(19) United States
(12) Patent Application Publication
(10) Pub. No.: US 2008/0035215 A1
(43) Pub. Date: Feb. 14, 2008

(54) Hydraulic System Safety Shut Off Valve

(76) Inventor: Donald Milton Loper, Milwaukee, WI (US)

Correspondence Address: GEHRKE & ASSOCIATES, S.C., 123 N. 86th ST, WAUWATOSA, WI, 53226, US

(21) Appl. No.: 11/836,302

(22) Filed: Aug. 9, 2007

Related U.S. Application Data
(60) Provisional application No. 60/837,600, filed on Aug. 9, 2006.

(51) Int. Cl. F15B 20/00; F16K 15/02

(52) U.S. Cl. 137/517

(57) ABSTRACT

The hydraulic system safety shut off valve is a safety valve for use immediately downstream from a hydraulic pressure power supply line and before the operational control valves and subsystems. It includes a velocity fuse having an inlet and an outlet, a surge chamber having an inlet and an outlet, and, a connecting port, which connects the inlet outlet of the velocity fuse to the inlet of the surge chamber.

### CROSS-REFERENCE TO RELATED APPLICATION

This application is a continuation of and claims priority of U.S. Provisional Patent Application No. 60/837,600, filed Aug. 9, 2006, the contents of which is hereby incorporated by references.

### BACKGROUND OF THE INVENTION

1. Field of Invention

The present invention relates to safety valves for use in full operational hydraulic systems and sub-systems.

2. Discussion of Relevant Prior Art

Hydraulic hose and line failures in the field create an extreme hazard for operators, work crews and the environment. Injuries resulting from hydraulic lines breaks happen almost daily. Although various shut off fuses exist, none of the current designs provide a reliable and cost effective method of shutting off fluid flow when a line break occurs.

Velocity fuses are currently used for emergency shut off of fluid flow within cylinder systems. They work by sensing flow across a control orifice. When the pressure differential within the system exceeds a predetermined range, a spring biased poppet or spool closes, shutting flow to the damaged hydraulic circuit. This provides for limited protection, as the load may be protected from free falling, but the system pump is still running. Under this condition the pump continues to push high pressure fluid into atmosphere until either the machine is turned off, or pump destroys itself from lack of lubrication. A significant about of fluid may already be lost and damage done to the operators and/or equipment. Because of this and other limitation, conventional velocity fuses are not practical as safety valves on the supply pressure side of hydraulic circuit that delivers flow to the whole operational system. Accordingly, a great need exists for a safety valve that can shut off the supply of pressurized fluid, air, water, or steam to the sub systems that has a catastrophic event where a ruptured component is venting to atmosphere.

### BRIEF SUMMARY OF THE INVENTION

The present invention is directed to a safety valve for use immediately downstream from a hydraulic power pump and safety relief valve on the pressure supply line and before the operational control valves and subsystems. This invention eliminates the need for expensive electronic feedback, flow, and pressure devices, by using the natural physics of fluid pressure and flow characteristics. Unlike velocity fuses currently known in the art, the valve of the present invention is not affected by flow rates or by hydraulic control valves with tandem or open center positions. Furthermore, the present invention will continue to allow flow even if the system is in a neutral position.

More specifically, the present invention is directed to a safety shut off valve comprising a velocity fuse coupled with a surge chamber. When used within a system, fluid flows through the fuse and into the adjacent surge chamber before exiting into the rest of the system. The chamber acts as an accumulator of fluid. This accumulation controls and changes the orientation of flow thus increasing differential pressure on surface of the velocity fuse which is enough to keep the fuse from prematurely shutting off during normal fluctuations in system flow. As a result, the fuse within the valve will not close until a catastrophic line rupture causes an increase in differential pressure through the drop in the chamber volume.

The chamber can be changed in shape and size to facilitate the desired system. The chamber can also be adjustable in shape and size through manufacturing or controlled by air, mechanical, electrical, pilot operation, or manually means but not limited to those shown.

### BRIEF DESCRIPTION OF THE DRAWINGS

FIG. 1 is a cross sectional view of the safety valve in open flow position.

FIG. 2 is a cross sectional view of the safety valve in closed flow position.

### DETAILED DESCRIPTION OF THE INVENTION

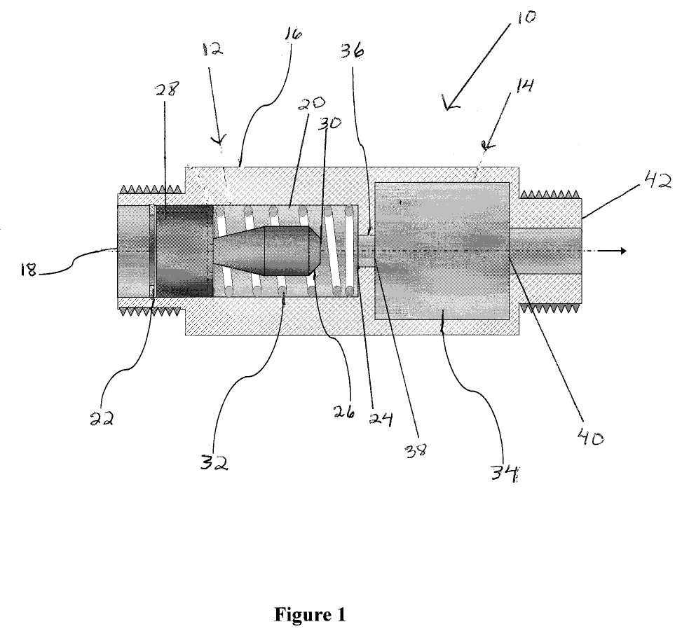

Referring now to FIG. 1, the present invention is directed to a hydraulic system safety valve 10 includes a velocity fuse 12 coupled to a surge chamber 14 which are contained within housing 16. When in use the safety valve 10 is positioned directly downstream from a hydraulic pressure power supply line and before the operational control valves. When positioned within the hydraulic system, fluid flows from the system into the safety valve through inlet port 18 and enters velocity fuse chamber 20.

The velocity fuse chamber 20 is defined by chamber inlet 22 and chamber outlet 24. The chamber diameter is predetermined by the system requirements. A spool 26 having a positioning end 28 and a valve end 30 is aligned within the fuse chamber 20 so that the valve end 30 will close off the fuse chamber outlet 24 when the velocity fuse 12 is in a closed position. The spool 26 is of a diameter and length that will allow the spool 26 to slide within the fuse chamber 20 in accordance with the requirements of the system. A compression spring 32 is positioned between the valve end 30 of the spool 26 and the fuse chamber outlet 24. As fluid exits the velocity fuse chamber 20 through fuse chamber outlet 24, it enters a surge accumulator 34 via connecting port 36.

Fluid flowing through the connecting port 36 enters the accumulator 34 through a surge chamber inlet 38, and exits the accumulator 34 through a surge chamber outlet 40 which empties back into the system through valve outlet port 42. The accumulator 34 acts to disrupt and slow the flow of the fluid through the system, thereby providing a backpressure against the velocity fuse 12. As a result, normal pressure surges created during the normal operation if the hydraulic system which would typically result in a closure of a conventional velocity valve, will be damped by the backpressure created by the accumulator 34. The size and shape of the accumulator 34 will vary and will be determined by the pressure differential requirements for each system.

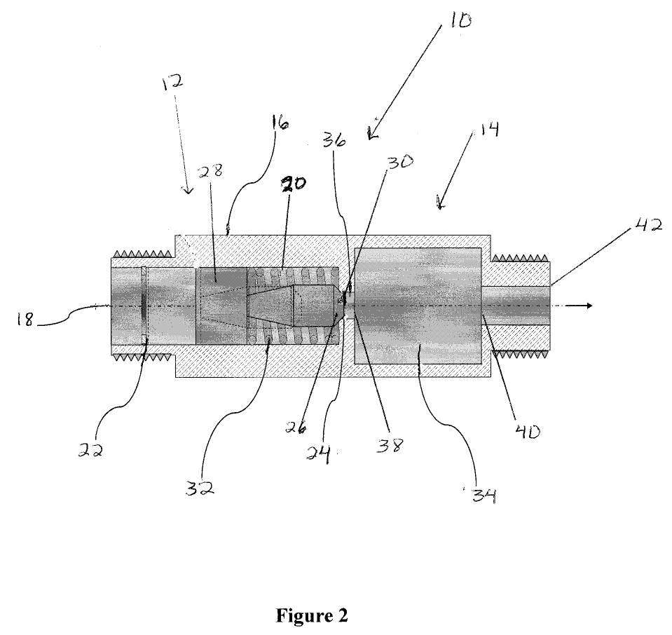

Referring now to FIG. 2, if a catastrophic line break occurs within the hydraulic system, the fluid level within the accumulator 34 of the safety valve 10 will immediately drop, thereby increasing the differential pressure beyond the preset bias of spring 30. Consequentially, the velocity of the fluid flowing into the velocity fuse chamber 20 will slide the spool 26 against the fuse chamber outlet 24 thereby stopping the flow of fluid through the safety valve 10 and the whole hydraulic system.

While we have shown and described the preferred embodiments of my invention, it will be understood that the invention may be embodied otherwise than as herein specifically illustrated or described, and that certain changes in form and arrangement of parts and the specific manner of practicing the invention may be made within the underlying idea or principles of the invention.

I claim:

1. A hydraulic system safety valve comprising:
a velocity fuse having an inlet and an outlet;
a surge chamber having an inlet and an outlet; and,
a connecting port which connects the outlet of the velocity fuse to the inlet of the surge chamber.

2. A hydraulic system comprising:
a hydraulic pressure power supply line;
at least one operational control valve; and
a hydraulic system safety valve positioned between the hydraulic pressure power supply and at least one operational control valve.

3. The hydraulic system of claim 2, wherein the hydraulic safety valve comprises:
a velocity fuse having an inlet and an outlet;
a surge chamber having an inlet and an outlet; and,
a connecting port which connects the inlet outlet of the velocity fuse to the inlet of the surge chamber.
